(19) United States
(12) Patent Application Publication
(10) Pub. No.: US 2015/0261296 A1
(43) Pub. Date: Sep. 17, 2015

(54) ELECTRONIC APPARATUS, HAPTIC FEEDBACK CONTROL METHOD, AND PROGRAM

(71) Applicant: CANON KABUSHIKI KAISHA, Tokyo (JP)

(72) Inventor: Akio Yoshikawa, Tokyo (JP)

(21) Appl. No.: 14/645,253

(22) Filed: Mar. 11, 2015

(30) Foreign Application Priority Data
Mar. 14, 2014 (JP) 2014052648

(51) Int. Cl. G06F 3/01; G06F 3/041

(52) U.S. Cl. CPC G06F 3/016; G06F 3/041

(57) ABSTRACT

To reduce an unnecessary haptic feedback generation process and cause a user to suitably perceive a feedback to an operation by a manipulator, a specifying unit configured to specify a touch area of a touch input to an input screen using a manipulator by a user; a first haptic feedback generating unit configured to generate a haptic feedback provided to a manipulator via the input screen; a determination unit configured to determine to generate the haptic feedback if the touch area is equal to or greater than an area threshold, and determine not to generate the haptic feedback if the touch area is smaller than the area threshold; and a control unit configured to instruct the first haptic feedback generating unit to generated the haptic feedback if it is determined to generate the haptic feedback are provided.

### BACKGROUND OF THE INVENTION

1. Field of the Invention

The present invention relates to an electronic apparatus, a haptic feedback control method, and a program.

2. Description of the Related Art

In recent electronic apparatuses, including mobile phones, bank ATMs, tablet PCs, and car navigation systems, a touch sensor, such as a touch panel, is widely used as an input device that receives an input from an operator. Various types of touch sensors, such as a resistance film system touch sensor and a capacitive touch sensor, are proposed.

The touch sensor itself is not physically displaced as button switches do. Therefore, an operator touching the touch sensor in any of the systems with a finger or a stylus pen does not obtain a feedback about the input. Therefore, the operator cannot check whether the input has been successfully performed. Since the operator cannot check whether an input has been successfully performed, the operator may perform the touch operation repeatedly. Thus, some touch sensors may be stressful to the operator because of the lack of feedbacks.

To address this problem, Japanese Patent Laid-Open No. 2011-048671 discloses, for example, a technique of causing, when a touch sensor receives an input, an operator to recognize, by a haptic feedback, that the input has been successfully received by vibrating a touch surface of the touch sensor to provide, for example, a finger with the haptic feedback.

In the related art, the haptic feedback is provided without distinguishing whether a manipulator is a finger or a stylus pen. It is difficult, however, to cause the operator to perceive the haptic feedback even if a haptic feedback is generated when a user operates with a manipulator, such as a stylus pen. Further, the related art is inefficient in power consumption.

### SUMMARY OF THE INVENTION

An aspect of the present invention solves all or at least one of the above problems.

An aspect of the present invention includes: a specifying unit configured to specify a touch area of a touch input to an input screen using a manipulator by a user; a first haptic feedback generating unit configured to generate a haptic feedback provided to a manipulator via the input screen; a determination unit configured to determine to generate the haptic feedback if the touch area is equal to or greater than an area threshold, and determine not to generate the haptic feedback if the touch area is smaller than the area threshold; and a control unit configured to instruct the first haptic feedback generating unit to generated the haptic feedback if it is determined to generate the haptic feedback.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an electronic apparatus.

FIG. 2 is a diagram illustrating an example in which a user touches a touch panel with a finger.

FIG. 3 is a diagram illustrating an example in which a user touches the touch panel with a stylus pen.

FIG. 4 is a flowchart of a haptic feedback control process.

FIG. 5 is a flowchart of a haptic feedback control process.

FIG. 6 is a flowchart of a haptic feedback control process.

### DESCRIPTION OF THE EMBODIMENTS

Various exemplary embodiments, features, and aspects of the invention will be described in detail below with reference to the drawings.

Hereinafter, embodiments of the present invention will be described with reference to the drawings.

### First Embodiment

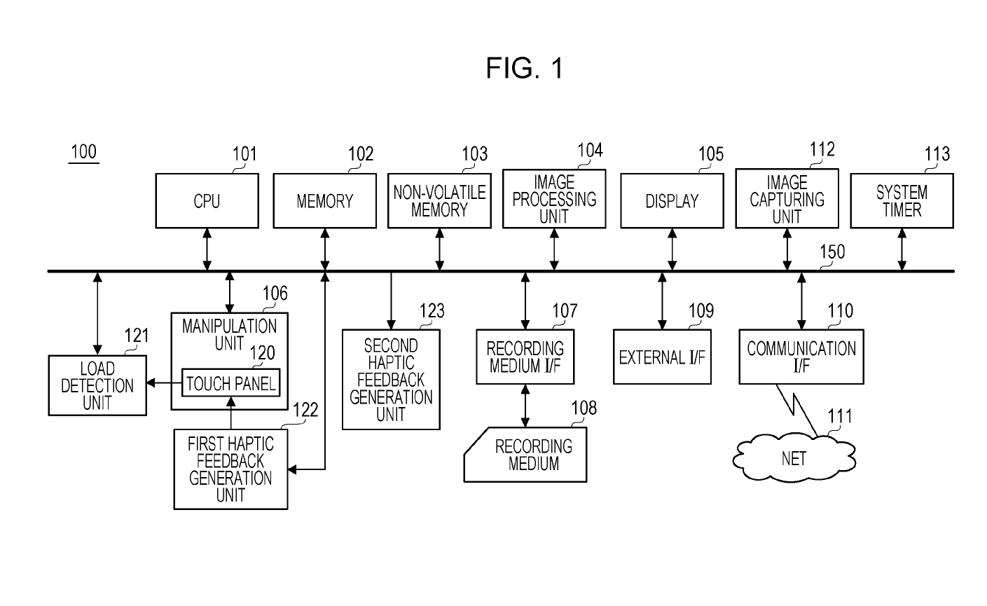

FIG. 1 is a diagram illustrating an electronic apparatus 100. The electronic apparatus 100 is, for example, a mobile phone. As illustrated in FIG. 1, a CPU 101, a memory 102, a non-volatile memory 103, an image processing unit 104, a display 105, a manipulation unit 106, a recording medium I/F 107, an external I/F 109, and a communication I/F 110 are connected to an internal bus 150. Further, an image capturing unit 112, a load detection unit 121, a first haptic feedback generation unit 122, and a second haptic feedback generation unit 123 are connected to the internal bus 150. Each component connected to the internal bus 150 can exchange data via the internal bus 150.

The memory 102 is provided with, for example, RAM (e.g., volatile memory using a semiconductor device). The CPU 101 controls each component of the electronic apparatus 100 in accordance with, for example, a program stored in the non-volatile memory 103 using the memory 102 as a work memory. Image data, audio data, other data, and various programs to cause the CPU 101 to operate, and other data are stored in the non-volatile memory 103. The non-volatile memory 103 is provided with, for example, hard disk (HD) and ROM.

The image processing unit 104 performs various kinds of image processing to the image data under the control of the CPU 101. The image data to which the image processing is performed include image data stored in the non-volatile memory 103 or a recording medium 108, an image signal obtained via the external I/F 109, image data obtained via the communication I/F 110, and image data captured by the image capturing unit 112.

The image processing performed by the image processing unit 104 includes A/D conversion, D/A conversion, encoding of image data, compression, decoding, enlarging/reducing (resizing), noise reduction, and color conversion. The image processing unit 104 is, for example, a circuit block dedicated for performing particular image processing. Depending on the type of image processing, the CPU 101, instead of the image processing unit 104, may execute the image processing in accordance with the program.

The display 105 displays, for example, a GUI screen that constitutes an image and a graphical user interface (GUI) under the control of the CPU 101. The CPU 101 controls each component of the electronic apparatus 100 to generate a display control signal in accordance with the program, generate an image signal to be displayed on the display 105, and output the generated image signal to the display 105. The display 105 displays an image in accordance with the image signal.

Alternatively, the electronic apparatus 100 may be provided with an interface, instead of the display 105, for outputting the image signal to be displayed on the display 105. In this case, the electronic apparatus 100 displays, for example, an image in an external monitor (e.g., a television).

The manipulation unit 106 is an input device for receiving a user manipulation, including a character information input device, such as a keyboard, a pointing device, such as a mouse and a touch panel 120, a button, a dial, a joystick, a touch sensor, and a touchpad. The touch panel 120 is a plate-shaped input device placed over the display 105, and outputs coordinate information in accordance with a touched position. The touch panel 120 is an example of an input screen.

A recording medium 108, such as a memory card, a CD and a DVD may be attached to the recording medium I/F 107. Under the control of the CPU 101, the recording medium I/F 107 reads data from and writes data in the recording medium 108 attached thereto.

The external I/F 109 is an interface that connects with an external apparatus by a wired cable or in a wireless manner, for input and output of the image signal and an audio signal. The communication I/F 110 is an interface that communicates with, for example, an external apparatus or the Internet 111 (including a telephone communication) to transmit and receive various types of data, such as a file and a command.

The image capturing unit 112 is a camera unit provided with, for example, an image capturing element, such as a CCD sensor and a CMOS sensor, a zoom lens, a focus lens, a shutter, a diaphragm, a distance measurement unit, and an A/D converter. The image capturing unit 112 may capture a still image and a moving image. The image data of the image captured by the image capturing unit 112 is transmitted to the image processing unit 104, subject to various types of processing in the image processing unit 104, and then recorded on the recording medium 108 as a static image file or a dynamic image file.

A system timer 113 measures time taken for various types of control, and the time of a built-in clock.

The CPU 101 receives coordinate information of a touch position output from the touch panel 120 via the internal bus 150. The CPU 101 detects the following operations and states in accordance with the coordinate information.
Touching the touch panel 120 with a finger or a pen (hereafter, referred to as touch-down).
A state in which the touch panel 120 is touched by a finger or a pen (hereafter, referred to as touch-on).
Moving while touching the touch panel 120 with a finger or a pen (hereafter, referred to as move).
Removing a finger or a pen from the touch panel 120 (hereafter, referred to as touch-up).
A state in which nothing touches the touch panel 120 (hereafter, referred to as touch-off).

If the CPU 101 detects a movement of a finger of a pen, the CPU 101 further determines a direction in which the finger or the pen moves in accordance with a coordinate change of the touch position. Specifically, the CPU 101 determines vertical components and horizontal components of the moving direction on the touch panel 120.

The CPU 101 also detects stroking, flicking, and dragging. The CPU 101 detects stroking when touch-up occurs after touch-down and a certain distance of move. The CPU 101 detects flicking when move of a predetermined distance or longer and at a predetermined speed or higher is detected and subsequently touch-up is detected. The CPU 101 detects dragging when move of a predetermined distance or shorter and lower than a predetermined speed is detected.

Flicking is an operation of moving a finger a certain distance on the touch panel 120 quickly, and then removing the finger from the touch panel 120. That is, flicking is an operation of quickly tracing, like flipping, the touch panel 120 with a finger.

The touch panel 120 may be of various types of touch panels, such as a resistance film system touch panel, a capacitive touch panel, a surface acoustic wave touch panel, an infrared touch panel, an electromagnetic induction touch panel, an image recognition touch panel, and an optical sensor touch panel.

The load detection unit 121 is provided integrally with the touch panel 120 by, for example, an adhesive. The load detection unit 121 is a strain gauge sensor that detects load (pressure) applied to the touch panel 120 using a slight amount of bending (distortion) of the touch panel 120 in response to the pressure of the touch operation. Alternatively, the load detection unit 121 may be provided integrally with the display 105. In this case, the load detection unit 121 detects load applied to the touch panel 120 via the display 105.

The first haptic feedback generation unit 122 generates a haptic feedback applied to a manipulator that manipulates the touch panel 120, such as a finger and a pen. The first haptic feedback generation unit 122 is provided integrally with the touch panel 120 by, for example, an adhesive. The first haptic feedback generation unit 122 is a piezo-electric element, and more specifically, is a piezoelectric vibrator, that vibrates with an arbitrary amplitude and at an arbitrary frequency under the control of the CPU 101. Thus, the touch panel 120 vibrates in a curved manner and the vibration of the touch panel 120 is transferred to the manipulator as a haptic feedback. That is, the first haptic feedback generation unit 122 vibrates to provide the manipulator with a haptic feedback.

Alternatively, the first haptic feedback generation unit 122 may be provided integrally with the display 105. In this case, the first haptic feedback generation unit 122 causes the touch panel 120 to vibrate in a curved manner via the display 105.

The CPU 101 may generate various patterns of haptic feedback by changing the amplitude and the frequency of the first haptic feedback generation unit 122, and causing the first haptic feedback generation unit 122 to vibrate in the various patterns.

The CPU 101 may control the haptic feedback in accordance with the touch position detected on the touch panel 120, and pressure detected by the load detection unit 121. For example, suppose that, in response to a touch operation of the manipulator, the CPU 101 has detected a touch position corresponding to a button icon displayed on the display 105, and the load detection unit 121 has detected pressure of a predetermined value or greater. In this case, the CPU 101 generates vibration about a period. Thus, a user may perceive a haptic feedback as that of a click feeling when a mechanical button is pressed.

The CPU 101 executes the function of the button icon only when the CPU 101 detects pressure of a predetermined value or greater in a state in which touch at a position of the button icon has been detected. That is, the CPU 101 does not execute the function of the button icon when the CPU 101 detects weak pressure applied, for example, by a user simply touching the button icon. Thus, the user may operate with a feeling of pressing a mechanical button.

The load detection unit 121 is not limited to the strain gauge sensor. Alternatively, the load detection unit 121 may be provided with a piezoelectric transducer. In this case, the load detection unit 121 detects load in accordance with a voltage output from the piezoelectric transducer depending on the pressure. In this case, a pressure element as the load detection unit 121 may be common as the pressure element of the first haptic feedback generation unit 122.

The first haptic feedback generation unit 122 is not limited to the unit that generates vibration by the pressure element. Alternatively, the first haptic feedback generation unit 122 may generate an electrical haptic feedback. For example, the first haptic feedback generation unit 122 is provided with a conductive layer panel and an insulating material panel. Here, like the touch panel 120, the conductive layer panel and the insulating material panel are plate-shaped and placed over the display 105. When the user touches the insulating material panel, positive charge is charged in the conductive layer panel. That is, the first haptic feedback generation unit 122 may generate a haptic feedback as electrical stimulation by charging positive charge in the conductive layer panel. The first haptic feedback generation unit 122 may provide the user with a feeling (a haptic feedback) that the skin is pulled by the coulomb force.

Alternatively, the first haptic feedback generation unit 122 may be provided with a conductive layer panel on which the user can select whether to charge the positive charge for each position on the panel. The CPU 101 controls a charging position of the positive charge. Thus, the first haptic feedback generation unit 122 may provide the user with various haptic feedbacks, including “a feeling of a rugged surface,” “a feeling of a rough surface,” and “a feeling of a smooth surface.”

A second haptic feedback generation unit 123 generates a haptic feedback by causing the entire electronic apparatus 100 to vibrate. The second haptic feedback generation unit 123 is provided with, for example, an eccentric motor and implements, for example, a publicly known vibration function. Thus, the electronic apparatus 100 may provide, for example, a hand of the user holding the electronic apparatus 100, with a haptic feedback by the vibration generated by the second haptic feedback generation unit 123.

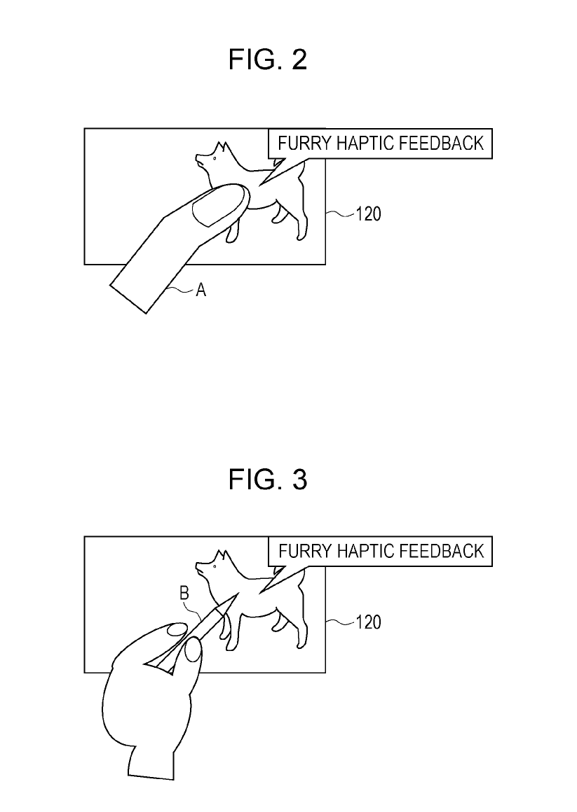

Examples of the manipulators with which operations are input in the touch panel 120 of the electronic apparatus 100 may be a part of the user's body, a finger for example, as illustrated in FIG. 2, and a pointing device, such as a stylus pen as illustrated in FIG. 3. The electronic apparatus 100 according to the present embodiment performs a process to provide the manipulator with a haptic feedback as a feedback about the operation by the manipulator.

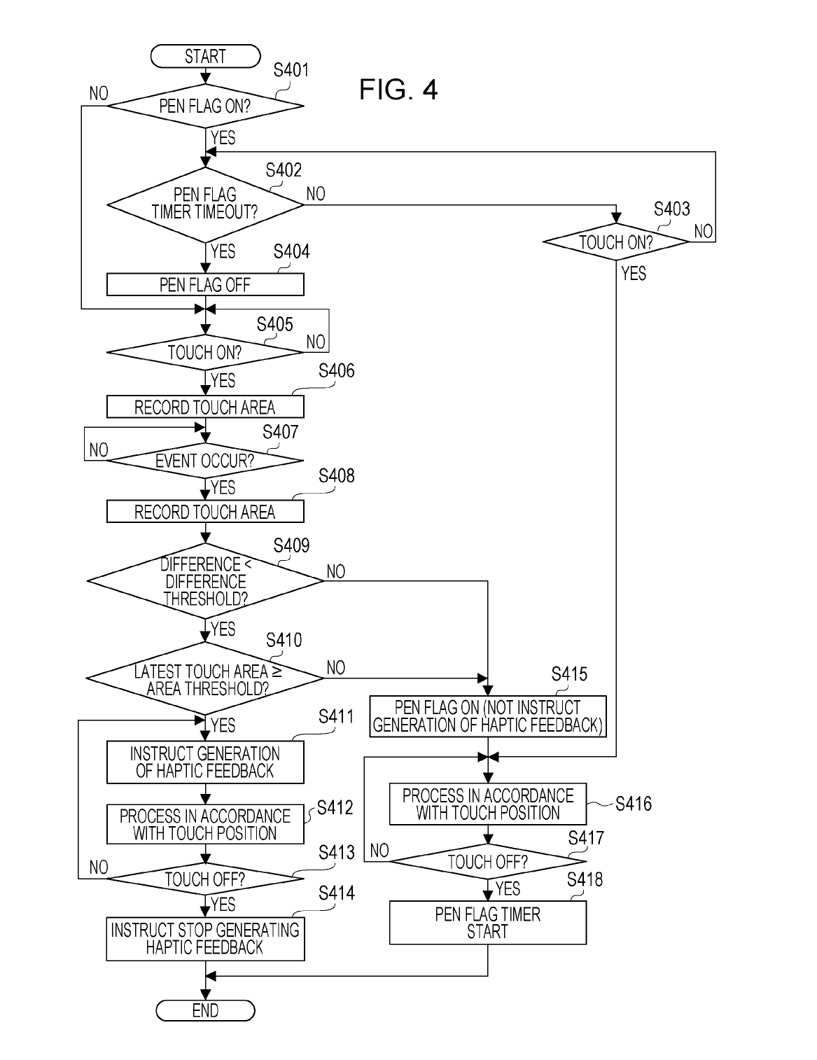

FIG. 4 is a flowchart of the haptic feedback control process executed by the electronic apparatus 100. The haptic feedback control process is implemented by the CPU 101 reading the program stored in, for example, the non-volatile memory 103 and executing the program. In S401, the CPU 101 checks a value of a pen flag. Here, the pen flag is binary information indicating the kind of the manipulator, in which “on” indicates a stylus pen and “off” indicates a finger. The pen flag is stored in the memory 102. The value of the pen flag is set in S404 described below with respect to the previous operation by the user.

If the pen flag value is “on” (S401: Yes), the CPU 101 forwards the process to S402. If the pen flag value is “off” (S401: No), the CPU 101 forwards the process to S405.

In S402, CPU 101 determines whether a pen flag timer times out. The pen flag timer is used to determine whether the user has put the stylus pen and switched to touch with the finger. In the present embodiment, the pen flag timer is set to 500 msec. The set time of the pen flag timer is not limited to that of the present embodiment. The pen flag timer is set in S418 described below with respect to the previous operation. If time is out (S402: Yes), the CPU 101 forwards the process to S404. If time is not out (S402: No), the CPU 101 forwards the process to S403.

In S403, the CPU 101 checks whether the user has touched the touch panel 120, i.e., determines the existence of touch-on. If touch-on is detected (S403: Yes), the CPU 101 forwards the process to S416. If touch-on is not detected (S403: No), the CPU 101 forwards the process to S402. Here, the process of S403 is an example of a detection process to detect the touch input.

In S404, the CPU 101 turns the pen flag “off.” Next, in S405, the CPU 101 checks the existence of touch-on. If touch-on is detected (S404: Yes), the CPU 101 forwards the process to S406. If touch-on is not detected (S404: No), the CPU 101 stands by until touch-on is detected. In S406, the CPU 101 specifies a touch area and records the specified touch area in the memory 102. Here, the touch area means an area in which the manipulator touches the touch panel 120 during touch-on. The process in S406 is an example of the specifying process to specify the touch area.

Next, in S407, the CPU 101 waits for an event from the manipulation unit 106 and, when a notification of an event generation is received (S407: Yes), the CPU 101 forwards the process to S408. In S408, the CPU 101 specifies the touch area again and records the specified touch area in the memory 102. The touch area already stored in the memory 102 is not deleted. The touch area is accumulated in the order of specification in an area memory arrangement of the memory 102.

Next, in S409, the CPU 101 refers to the touch area stored in the memory 102 and calculates a difference between the most recent touch area and a previous touch area. The CPU 101 compares the difference with a difference threshold. The difference threshold is stored in, for example, the non-volatile memory 103 in advance. If the difference is smaller than the difference threshold (S409: Yes), the CPU 101 determines that the value of the touch area is stabilized and forwards the process to S410. If the difference is equal to or greater than the difference threshold (S409: No), the CPU 101 forwards the process to S415.

The process of S409 is an example of a calculation process to calculate a difference between a first touch area specified at first timing during the touch input in S406 and a second touch area specified at second timing during touch input in S408.

In the case of touch-on with a finger, it is assumed that the touch area is stabilized at a substantially constant value after being gradually increased. The process of S409 is to check whether the value of the touch area is stabilized in response to this operation.

In S410, the CPU 101 compares the most recent touch area with an area threshold. The area threshold is stored in, for example, the non-volatile memory 103 in advance. The area threshold is a value with which whether the manipulator is a finger or a stylus pen is determined, that is, a value greater than the touch area of the stylus pen. If the touch area is equal to or greater than the area threshold (S410: Yes), the CPU 101 forwards the process to S411. If the touch area is smaller than the area threshold (S410: No), the CPU 101 forwards the process to S415.

In S411, the CPU 101 determines to generate a haptic feedback (a determination process), and instructs the first haptic feedback generation unit 122 to generate the haptic feedback (a control process). The first haptic feedback generation unit 122 generates the haptic feedback to be provided to the user in response to the instruction of the CPU 101 (a haptic feedback generation process). In S412, the CPU 101 performs a process in accordance with a touch position that is touched down. The process in accordance with a touch position includes a process to change the GUI by the touch operation, such as changing the display of a button displayed on a position on the display 105 corresponding to the touch position, and drawing a line.

Next, in S413, the CPU 101 checks whether the manipulator has been removed from the touch panel 120, and checks the existence of touch-off. If touch-off is detected (S413: Yes), the CPU 101 forwards the process to S414. If touch-off is not detected (S413: No), the CPU 101 forwards the process to S411.

In S414, the CPU 101 instructs the first haptic feedback generation unit 122 to stop generation of the haptic feedback started in S411. In response to the instruction, the first haptic feedback generation unit 122 stops generation of the haptic feedback.

The haptic feedback generation process is thus completed.

That is, if it is determined to generate the haptic feedback, the CPU 101 continues instructing to generate the haptic feedback until touch-off is detected (i.e., touch input is no longer detected). In response to this, the first haptic feedback generation unit 122 continues generating the haptic feedback until touch-off is detected.

In S415, the CPU 101 determines not to generate the haptic feedback and turns the pen flag “on.” In this case, the CPU 101 does not instruct to generate the haptic feedback (if the most recent touch area is smaller than the area threshold, or if the difference is equal to or greater than the difference threshold). Next, in S416, the CPU 101 performs a process in accordance with the touch position. The process in S416 is the same as the process in S412.

Next, in S417, the CPU 101 checks the existence of touch-off. If touch-off is detected (S417: Yes), the CPU 101 forwards the process to S418. If touch-off is not detected (S417: No), the CPU 101 forwards the process to S416. In S418, the CPU 101 causes the pen flag timer to start. The haptic feedback generation process is thus completed.

That is, if it is determined not to generate the haptic feedback, the CPU 101 does not instruct to generate the haptic feedback until touch-off is detected. In response to this, the first haptic feedback generation unit 122 does not generate the haptic feedback until touch-off is detected.

If it is determined not to generate the haptic feedback, the CPU 101 turns the pen flag timer on and does not perform the processes of S404 to S415 until the pen flag timer times out. That is, during this period, the CPU 101 does not instruct to generate the haptic feedback regardless of the touch area. Thus, process load of the electronic apparatus 100 can be reduced. Here, the timing at which the pen flag timer times out is an example of the timing at which first time elapses since detection timing of the touch input.

As described above, if the most recent touch area is equal to or greater than the area threshold, the electronic apparatus 100 generates the haptic feedback and, if the touch area is smaller than the area threshold, the electronic apparatus 100 does not generate the haptic feedback. Thus, the electronic apparatus 100 can reduce an unnecessary haptic feedback generation process, and reduce power consumption.

The electronic apparatus 100 compares the most recent touch area with the area threshold, after checking that the value of the touch area had been stabilized in comparison with the most recent touch area and the previous touch area. Thus, whether the manipulator is a finger can be determined accurately.

As a first modification of the electronic apparatus 100 of the first embodiment, CPU 101 may determine whether to generate the haptic feedback only in accordance with the comparison between the most recent touch area and the area threshold. That is, if the most recent touch area is equal to or greater than the area threshold, the CPU 101 may determine to generate the haptic feedback and, if the most recent touch area is smaller than the area threshold, the CPU 101 may determine not to generate the haptic feedback.

As a second modification, if a difference between the most recent touch area and the previous touch area is equal to or greater than an area difference, the CPU 101 may estimate that the manipulator is a soft object, i.e., a finger, and may determine to generate a haptic feedback. If a difference between the most recent touch area and the previous touch area is smaller than an area threshold, the CPU 101 may estimate that the manipulator is a hard object, i.e., a stylus pen, and may determine not to generate a haptic feedback.

As a third modification, the area threshold used in S410 may be a value for determining whether the manipulator is a finger, and whether the touch area is large enough to provide the manipulator with an appropriate haptic feedback. If the touch area is excessively small, it is difficult to cause the user to perceive an appropriate haptic feedback even if the manipulator is a finger. In the third modification, the electronic apparatus 100 can generate the haptic feedback by using the area threshold set from a viewpoint of providing a user with an appropriate haptic feedback, only in a case in which a user is reliably provided with the haptic feedback.

### Second Embodiment

Next, an electronic apparatus 100 according to a second embodiment is described. The electronic apparatus 100 according to the second embodiment causes the electronic apparatus 100 to vibrate by a second haptic feedback generation unit 123, if a haptic feedback is not generated by a first haptic feedback generation unit 122.

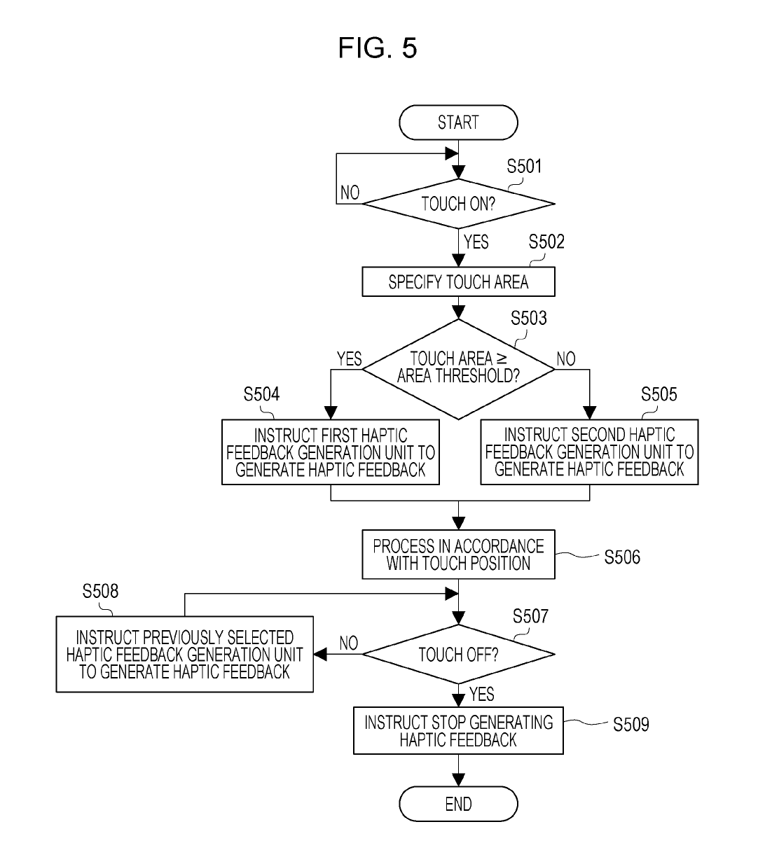

FIG. 5 is a flowchart of a haptic feedback control process executed by the electronic apparatus 100 according to the second embodiment. In S501, a CPU 101 checks the existence of touch-on. If touch-on is detected (S501: Yes), the CPU 101 forwards the process to S502. If touch-on is not detected (S501: No), the CPU 101 stands by until touch-on is detected.

In S502, the CPU 101 specifies a touch area. In S503, the CPU 101 compares the touch area with an area threshold. If the touch area is equal to or greater than the area threshold (S503: Yes), the CPU 101 forwards the process to S504. If the touch area is smaller than the area threshold (S503: No), the CPU 101 forwards the process to S505. In S504, the CPU 101 determines to generate the haptic feedback by the first haptic feedback generation unit 122, and selects the first haptic feedback generation unit 122. The CPU 101 instructs the selected first haptic feedback generation unit 122 to generate the haptic feedback and forwards the process to S506. The first haptic feedback generation unit 122 generates the haptic feedback in response to the instruction of the CPU 101.

In S505, the CPU 101 determines not to generate the haptic feedback by the first haptic feedback generation unit 122, and selects the second haptic feedback generation unit 123. The CPU 101 instructs the second haptic feedback generation unit 123 to generate the haptic feedback and forwards the process to S506. The second haptic feedback generation unit 123 generates the haptic feedback in response to the instruction of the CPU 101.

That is, if the touch area is equal to or greater than the area threshold, the electronic apparatus 100 performs a local haptic feedback to the touch position and, if the touch area is smaller than the area threshold, the electronic apparatus 100 performs a feedback of vibrating the entire electronic apparatus 100.

In S506, the CPU 101 performs a process in accordance with the touch position. The process of S506 is the same as the process in S412. Next, in S507, the CPU 101 checks the existence of touch-off. If touch-off is detected (S507: Yes), the CPU 101 forwards the process to S509. If touch-off is not detected (S507: No), the CPU 101 forwards the process to S508.

In S508, the CPU 101 continues instructing the haptic feedback generation unit selected in S504 or S505 (the first haptic feedback generation unit 122 or the second haptic feedback generation unit 123) to generate the haptic feedback. In S509, the CPU 101 instructs to stop generating the haptic feedback. The haptic feedback generation process is thus completed.

The electronic apparatus 100 according to the second embodiment does not cause the first haptic feedback generation unit 122 to generate the haptic feedback if the touch area is smaller than the area threshold. Thus, unnecessary power consumption related to the haptic feedback generation can be reduced.

If the touch area is smaller than the area threshold, the electronic apparatus 100 according to the second embodiment causes the second haptic feedback generation unit 123 to generate the haptic feedback. Thus, also in s situation in which the haptic feedback to a finger as a manipulator is not suitable, including a case in which the user is using a stylus pen as the manipulator, or a case in which a touch area of the finger is small, the feedback to the user can be implemented reliably. That is, the electronic apparatus 100 can implement the feedback in accordance with the situation by selecting either one of the first haptic feedback generation unit 122 and the second haptic feedback generation unit 123 depending on the touch area.

Other configurations and processes of the electronic apparatus 100 according to the second embodiment than those described are the same as those of the electronic apparatus 100 according to the first embodiment.

Next, a first modification of the electronic apparatus 100 according to the second embodiment is described. In the second embodiment, for the ease of description, whether to perform the haptic feedback by the first haptic feedback generation unit 122 generating the haptic feedback is determined only by the comparison between the touch area and the area threshold, the determination is not limited to the same.

Alternatively, as in the first embodiment, the electronic apparatus 100 may determine whether to perform the haptic feedback by comparing the most recent touch area with the area threshold after checking that the touch area has been stabilized. That is, in this case, in S416 illustrated in FIG. 4, immediately before performing the process in accordance with the touch position, the electronic apparatus 100 instructs second haptic feedback generation unit 123 to generate the haptic feedback. The second haptic feedback generation unit 123 causes the electronic apparatus 100 to vibrate in response to the instruction of the CPU 101.

As a second modification, the electronic apparatus 100 may be provided with, as the first haptic feedback generation unit 122, a vibration generation unit that generates a haptic feedback by vibration of a piezoelectric vibrator, and an electrical stimulation generation unit that generates an electrical haptic feedback. In this case, the CPU 101 instructs the vibration generation unit to generate vibration and instructs the electrical stimulation generation unit to generate electrical stimulation if the touch area is equal to or greater than a threshold. The CPU 101 may instruct the vibration generation unit to generate vibration and may instruct the electrical stimulation generation unit not to generate electrical stimulation if the touch area is smaller than a threshold.

The electrical stimulation provides a finger with a feeling (a haptic feedback) that the skin is pulled by the coulomb force and, therefore, if the touch area is small, it is difficult to cause the user to perceive an appropriate haptic feedback. On the other hand, vibration easily causes the user to perceive the haptic feedback even if the touch area is small as compared with the electrical stimulation. Accordingly, the electronic apparatus 100 according to this example provides only the haptic feedback by vibration and does not provide the haptic feedback by electrical stimulation if the touch area is smaller than a threshold.

### Third Embodiment

Next, an electronic apparatus 100 according to a third embodiment is described. An electronic apparatus 100 according to the third embodiment estimates whether a manipulator is a finger or a stylus pen in accordance with time taken until a touch area is stabilized, and determines whether to generate a haptic feedback by the first haptic feedback generation unit 122 depending on an estimation result.

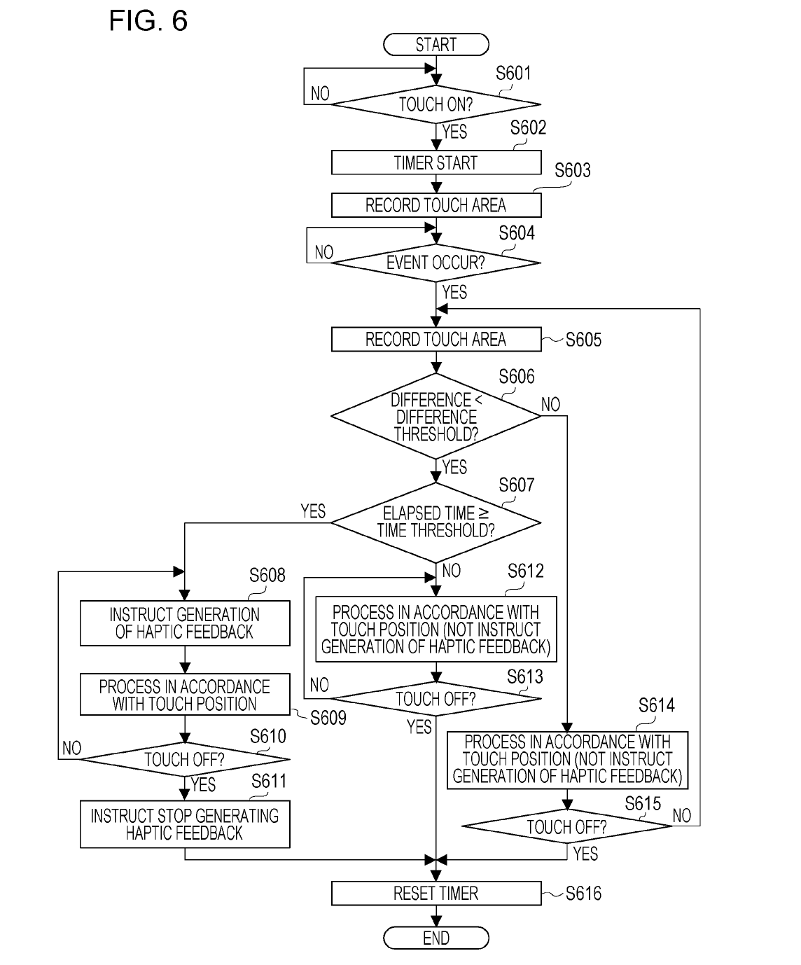

FIG. 6 is a flowchart of a haptic feedback control process executed by the electronic apparatus 100 according to the third embodiment. In S601, a CPU 101 checks the existence of touch-on. If touch-on is detected (S601: Yes), the CPU 101 forwards the process to S602. If touch-on is not detected (S601: No), the CPU 101 stands by until touch-on is detected.

In S602, the CPU 101 starts counting of a timer in accordance with temporal data obtained from a system timer 113. Next, in S603, the CPU 101 specifies a touch area and records the specified touch area in a memory 102. Next, in S604, the CPU 101 waits for an event from a manipulation unit 106 and, when a notification of an event generation is received (S604: Yes), the CPU 101 forwards the process to S605.

In S605, the CPU 101 specifies the touch area again and records the specified touch area in the memory 102. The touch area already stored in the memory 102 is not deleted. The touch area is accumulated in the order of specification in an area memory arrangement of the memory 102. Next, in S606, the CPU 101 refers to the touch area stored in the memory 102 and calculates a difference between the most recent touch area and a previous touch area. The CPU 101 compares the difference with a difference threshold.

If the difference is smaller than the difference threshold (S606: Yes), the CPU 101 determines that the value of the touch area is stabilized and forwards the process to S607. If the difference is equal to or greater than the difference threshold (S606: No), the CPU 101 forwards the process to S614.

In S614, the CPU 101 performs a process in accordance with the touch position. At this time, the CPU 101 does not instruct the first haptic feedback generation unit 122 to generate a haptic feedback. Next, in S615, the CPU 101 checks the existence of touch-off. If touch-off is detected (S615: Yes), the CPU 101 forwards the process to S616. If touch-off is not detected (S615: No), the CPU 101 forwards the process to S605. Then the CPU 101 specifies the touch area again and records the specified touch area in the memory 102.

With the processes above, the touch area is specified repeatedly in S604 until a difference in the touch area becomes smaller than a difference threshold and, the difference is compared with a difference threshold repeatedly for a specified touch area in S606. The processes of S603 and S605 are examples of area specifying processes to specify the touch area at different timing during the touch input.

In S607, the CPU 101 specifies elapsed time taken until the difference becomes smaller than the difference threshold in S606 after the timer is started in S602. Here, a state in which the difference becomes smaller than the difference threshold is an example of a state in which variations in the touch area specified within first time during the touch input become values within a reference range. The process of S607 is an example of a time specifying process. The CPU 101 compares the elapsed time with a time threshold. The time threshold is stored in, for example, the non-volatile memory 103 in advance. The time threshold is set to 0.1 sec in the present embodiment.

If the elapsed time is equal to or greater than the time threshold (S607: Yes), the CPU 101 forwards the process to S608. If the elapsed time is smaller than the time threshold (S607: No), the CPU 101 forwards the process to S612.

In S608, the CPU 101 estimates that the type of the manipulator is a finger, and determines to generate a haptic feedback by the first haptic feedback generation unit 122. The CPU 101 instructs the first haptic feedback generation unit 122 to generate the haptic feedback. Next, in S609, the CPU 101 performs a process according to the touch position. Next, in S610, the CPU 101 checks the existence of touch-off. If touch-off is detected (S610: Yes), the CPU 101 forwards the process to S611. If touch-off is not detected (S610: No), the CPU 101 forwards the process to S608.

In S611, the CPU 101 instructs the first haptic feedback generation unit 122 to stop generating the haptic feedback. In response to the instruction, the first haptic feedback generation unit 122 stops generation of the haptic feedback. Next, in S616, the CPU 101 resets the timer count. The haptic feedback control process is thus completed.

In S612, the CPU 101 estimates that the type of the manipulator is a stylus pen, and determines not to generate the haptic feedback by the first haptic feedback generation unit 122. The CPU 101 performs a process according to the touch position. Next, in S613, CPU 101 checks the existence of touch-off. If touch-off is detected (S613: Yes), the CPU 101 forwards the process to S616. If touch-off is not detected (S613: No), the CPU 101 forwards the process to S612.

As described above, the electronic apparatus 100 according to the third embodiment estimates whether the manipulator is a finger or a stylus pen in accordance with the elapsed time until the difference of the touch area becomes smaller than the difference threshold. The electronic apparatus 100 generates the haptic feedback by the first haptic feedback generation unit 122 only if it is estimated that the manipulator is a finger. That is, the electronic apparatus 100 according to the present embodiment can accurately estimate that manipulator is a finger, or a stylus pen and, can suitably determine whether to perform a haptic feedback generation process. Thus, the electronic apparatus 100 can reduce an unnecessary haptic feedback generation process, and reduce power consumption.

As a first modification of the electronic apparatus 100 of the third embodiment, the process for estimating the type of the manipulator is not limited to that of the embodiment. Alternatively, the user may use a stylus pen that can communicate with the electronic apparatus 100 through the Bluetooth (registered trademark). In this case, if the electronic apparatus 100 receives information from the stylus pen, (a reception process) by the Bluetooth communication, the electronic apparatus 100 may estimate that the user operates using a stylus pen, that is, the manipulator is a stylus pen.

As a second modification, the electronic apparatus 100 may be an apparatus that may receive designation of a position on the display 105 by eye-gaze detection or motion detection. In this case, the electronic apparatus 100 does not necessary have to perform a haptic feedback by the first haptic feedback generation unit 122 to the instruction by, for example, eye-gaze.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-052648, filed Mar. 14, 2014 which is hereby incorporated by reference herein in its entirety.

What is claimed is:

1. An electronic apparatus comprising:
a specifying unit configured to specify a touch area of a touch input to an input screen using a manipulator by a user;
a first haptic feedback generating unit configured to generate a haptic feedback provided to a manipulator via the input screen;
a determination unit configured to determine to generate the haptic feedback if the touch area is equal to or greater than an area threshold, and determine not to generate the haptic feedback if the touch area is smaller than the area threshold; and
a control unit configured to instruct the first haptic feedback generating unit to generated the haptic feedback if it is determined to generate the haptic feedback.

2. The electronic apparatus according to claim 1, further comprising:
a calculating unit configured to calculate a difference between a first touch area specified at first timing during touch input and a second touch area specified at second timing during the touch input after the first timing,
wherein the determination unit determines to generate the haptic feedback when the difference is smaller than a difference threshold and when the second touch area is equal to or greater than the area threshold.

3. The electronic apparatus according to claim 1, wherein,
if it is determined to generate the haptic feedback, the control unit continues instructing to generate the haptic feedback until the touch input is no more detected.

4. The electronic apparatus according to claim 1, wherein,
if it is determined not to generate the haptic feedback, the control unit does not instruct to generate the haptic feedback until first time elapses since detection timing of the touch input.

5. The electronic apparatus according to claim 1, further comprising:
a second haptic feedback generating unit configured to cause the entire electronic apparatus to vibrate,
wherein the control unit instructs the second haptic feedback generating unit to vibrate if it is determined not to generate the haptic feedback, and the control unit does not instruct the first haptic feedback generating unit to generate the haptic feedback.

6. The electronic apparatus according to claim 1, wherein the first haptic feedback generating unit generates a haptic feedback provided to the manipulator by electrical stimulation.

7. The electronic apparatus according to claim 6, further comprising:
a third haptic feedback generating unit configured to generate a haptic feedback provided to the manipulator by vibration,
wherein the control unit instructs the third haptic feedback generating unit to generate the haptic feedback if it is determined not to generate the haptic feedback, and the control unit does not instruct the first haptic feedback generating unit to generate the haptic feedback.

8. An electronic apparatus comprising:
a detection unit configured to detect touch input to an input screen using a manipulator by a user;
a first haptic feedback generating unit configured to generate a haptic feedback provided to a manipulator via the input screen;
an estimation unit configured to estimate whether the manipulator is a part of the user's body; and
a control unit configured to instruct the first haptic feedback generating unit to generate the haptic feedback if it is estimated that the manipulator is a part of the user's body.

9. The electronic apparatus according to claim 8, further comprising:
a receiving unit configured to receive information from a device as the manipulator,
wherein the estimation unit estimates that the manipulator is not a part of the user's body if the receiving unit receives information from the device.

10. The electronic apparatus according to claim 8, further comprising:
an area specifying unit configured to specify a touch area in the input screen of the touch input at different timings during touch input; and
a time specifying unit configured to specify elapsed time elapsed until variations in the touch areas specified in the first time during the touch input become within a reference range,
wherein the estimation unit estimates that the manipulator is a part of the user's body if the elapsed time is equal to or greater than a time threshold.

11. A haptic feedback control method executed by an electronic apparatus, the method comprising:
a specifying step to specify a touch area of a touch input to an input screen using a manipulator by a user;
a first haptic feedback generation step to generate a haptic feedback provided to a manipulator via the input screen;
a determination step to determine to generate the haptic feedback if the touch area is equal to or greater than an area threshold, and determine not to generate the haptic feedback if the touch area is smaller than the area threshold; and
a control step to instruct to generate the haptic feedback if it is determined to generate the haptic feedback.

12. A haptic feedback control method executed by an electronic apparatus, the method comprising:
a detecting step to detect touch input to an input screen using a manipulator by a user;
a first haptic feedback generation step to generate a haptic feedback provided to a manipulator via the input screen;
an estimation step to estimate whether the manipulator is a part of a user's body; and
a control step to instruct to generate the haptic feedback if it is estimated that the manipulator is a part of the user's body.

13. A program that causes a computer to function as:
a specifying unit configured to specify a touch area of a touch input to an input screen using a manipulator by a user;
a determination unit configured to determine to generate the haptic feedback if the touch area is equal to or greater than an area threshold, and determine not to generate the haptic feedback if the touch area is smaller than the area threshold; and
a control unit configured to instruct a first haptic feedback generating unit that generates the haptic feedback provided to the manipulator via the input screen to generate the haptic feedback if it is determined to generate the haptic feedback.

14. A program that causes a computer to function as:
a detection unit configured to detect touch input to an input screen using a manipulator by a user;
an estimation unit configured to estimate whether the manipulator is a part of the user's body; and
a control unit configured to instruct a first haptic feedback generating unit that generates the haptic feedback provided to the manipulator via the input screen to generate the haptic feedback if it is estimated that the manipulator is a part of the user's body.
